(19) United States
(12) Patent Application Publication
(10) Pub. No.: US 2014/0363290 A1
(43) Pub. Date: Dec. 11, 2014

(54) Method And System For Monitoring A Gearbox Of A Wind Energy Installation And Corresponding Wind Energy Installation

(71) Applicant: KENERSYS GMBH, Münster (DE)

(72) Inventor: Jörn Jacobsen, Munster (DE)

(21) Appl. No.: 14/363,466

(22) PCT Filed: Dec. 6, 2012
(86) PCT No.: PCT/EP2012/074685

§ 371 Date: Jun. 6, 2014

(30) Foreign Application Priority Data
Dec. 6, 2011 (DE) 102011056093.9

(51) Int. Cl. F03D 11/00; F03D 11/02

(52) U.S. Cl. CPC F03D 11/0091; F03D 11/02; F05D 2260/83
USPC 416/1; 416/61

(57) ABSTRACT

The invention relates to a method for monitoring a gearbox of a wind energy installation comprising. The invention further relates to a corresponding computer program product, a corresponding monitoring system for monitoring a gearbox of a wind energy installation and a corresponding wind energy installation.

The invention relates to a method for monitoring a gearbox of a wind energy installation comprising said gearbox and at least one gearbox fluid circuit. In the gearbox, at least one particle characteristic variable of particles contained in the gearbox fluid, in particular the quantity and/or the size and/or the type of these particles, is determined by measurement on at least one gearbox position in the gearbox and/or by fluid sampling on at least one gearbox position in the gearbox, and a subsequent measurement of the particles contained in the gearbox fluid in a path of the gearbox fluid circuit. The invention further relates to a corresponding computer program product, to a corresponding monitoring system for monitoring a wind energy installation comprising a gearbox and a gearbox fluid circuit, and to a corresponding wind energy installation.

Such a method is known as a method for monitoring the gearbox wear and for detecting signs of damage due to wear within the gearbox of a wind energy installation (WEI). Moreover, by means of such a monitoring method, messages and/or countermeasures can also be automatically generated and initiated.

In numerous wind energy installations, the rotation of the rotor is transferred via a gearbox to a generator. Here, strong torques are applied to the gearbox of the wind energy installation, which can lead to wear and abrasion on moving components of the gearbox. The torques applied to the gearbox during extreme wind gusts in particular can lead to serious gearbox damage. For a correct and reliable operation of the wind energy installation, it is therefore necessary to monitor whether the gearbox is in a proper operational state and whether the wear leads to any damage in the gearbox that is relevant to safety and/or to unnecessary downtimes of the wind energy installation.

DE 10 2008 048 956 A1 describes a method for monitoring a gearbox of a wind energy installation with a gearbox fluid circuit, in which the quantity and/or the size and/or the type of particles contained in the gearbox fluid is determined by measurement. If at least one, in particular the first, limit value is exceeded by a measurement value, a status communication is generated and/or an operating parameter of the wind energy installation is changed.

The aim of the invention is to indicate a monitoring method and a monitoring system which allow a more precise monitoring.

The aim is achieved according to the invention by the features of the independent claims. Advantageous embodiments of the invention are indicated in the dependent claims.

In the monitoring method according to the invention, it is provided that at least one operating characteristic variable is moreover determined, by means of which a current operating state of the wind energy installation and/or of the gearbox at the moment of the at least one measurement is determined, and wherein the at least one measurement is evaluated according to the operating state so determined. In general, the gearbox is interconnected in a wind energy installation between the rotor and the generator. The gearbox fluid is a gearbox lubricant and/or a gearbox coolant, in particular a gearbox oil. At least some of the operating characteristic variables relevant to the monitoring method, such as, for example, the rotational speed n of the rotor and/or the delivered power P of the generator of the wind energy installation, are in any case already determined in wind energy installations in connection with the automatic control of the installation. Based on the operating characteristic variables included in the monitoring, it is possible to distinguish at least roughly between different operating states. With the knowledge of the current operating state or respectively the current operating point of the wind energy installation and/or its gearbox, a substantially more precise analysis of wear and abrasion can be carried out based on the measurement result or the measurement results.

In addition to the determination of particle characteristic variables of the particles contained in the gearbox fluid, the particle detector, in a preferred embodiment of the invention, has at least one of the additional functions: collecting particles (for example, by generating magnetic fields) and/or evaluating the particle geometry (with regard to wear, pitting, etc.).

In the context of the invention, in a wind energy installation and its gearbox, the terms current operation, current operating state, etc., are connected with the generally constantly changing operating parameters and the associated operating point at which the WEI or its gearbox currently is.

According to a preferred embodiment of the invention, it is provided that several measurements of particles contained in the gearbox fluid of different gearbox positions are carried out, wherein the measurements, after having been weighted, are used in the evaluation. In particular, it is provided here that this weighting is selected according to the current operating state. This weighting in particular also includes such weighting operations in which, for example, the results determined in at least one of the possible operating states remain disregarded on at least one gearbox position. The corresponding weighting factor would thus be zero.

It is advantageous to provide that a wear site giving rise to particles in the gearbox is localized by evaluating the plurality of measurements, or that several wear sites giving rise to particles in the gearbox are localized by evaluating the plurality of measurements.

According to an additional preferred embodiment of the invention, it is provided that, the flow pattern (laminar flow or turbulent flow) of the flow of the gearbox fluid during operation in at least one first gearbox position of the gearbox positions is maintained by means of at least one fluidic structure in such a manner that it deviates in a controlled manner from the flow pattern of the flow of the gearbox fluid during operation in at least one second gearbox position of the gearbox positions. The structure is a guide plate or the like, for example.

In particular, it is provided that available flows are used in a controlled manner and/or flows are influenced or generated in a controlled manner Laminar flows defined by guide plates, for example, are directed to the corresponding gearbox position. Alternatively or additionally, the laminar flows restrained by guide plates detach so that the gearbox position is reached. Dead regions produced by detached laminar or turbulent flows are used in a defined manner as gearbox position. The detachment of the flow or the formation of dead regions is produced, for example, in a controlled manner by guide plates. Using guide plates shaped in any desired manner, the flow speeds can be adjusted. Moreover, flow speeds can be changed in a controlled manner by means of the gearbox fluid circuit.

As a result of the controlled use and/or influencing of the flow, particle accumulation points form in the gearbox. In accordance with the dead region, the different flow type and flow speed, collection structures, such as, for example, cavities in the gearbox housing or capturing plates are attached in order to accumulate particles. It is preferable to provide that the flow speed of the gearbox fluid during operation in at least one of the gearbox positions is greater than in at least another one of the gearbox positions, as in the other gearbox position. Using guide plates having any desired shape, or other structures, the flow speeds can be adjusted. Moreover, the flow speeds can be changed in a controlled manner by means of the gearbox fluid circuit.

According to yet another preferred embodiment of the invention, at least one of the gearbox positions is formed in a collection structure formed in the gearbox, for the purpose of accumulating particles contained in the gearbox fluid. In accordance with the dead regions, the different flow types and flow speed, collecting structures, for example, cavities in the housing or capturing plates are attached in order to accumulate particles.

It is advantageous to select the at least one operating characteristic variable from the group of the following operating characteristic variables:
rotational speed at the inlet of the gearbox,
torque at the inlet of the gearbox,
power of a generator of the wind energy installation,
wind speed in the region of a rotor of the wind energy installation,
ambient temperature of the gearbox,
quantity of the previous braking procedures for braking the rotor,
hours of operation of the gearbox and/or generator,
gearbox fluid temperature,
service intervals,
volume flow in the fluid pump, and
mechanical vibrations of the gearbox.

According to an additional design of the invention, it is provided that, in addition to the at least one particle characteristic variable, moreover at least one chemical and/or physical property and/or one chemical and/or physical state of the gearbox fluid is also detected. This also includes variables such as the relative humidity, the relative dielectric constant, and the conductivity and the temperature of the gearbox fluid.

It is preferable to determine several operating characteristic variables, by means of which the current operating state of the wind energy installation and/or the current operating state of the gearbox at the moment of the measurement or measurements is determined.

According to an additional preferred embodiment of the invention, it is provided that the gearbox fluid circuit comprises a particle filter, and that the measurements are also evaluated according to a current loading state of the particle filter.

Advantageously, the at least one measurement in the gearbox fluid circuit occurs upstream of the particle filter. In particular, the at least one measurement occurs within a gearbox housing.

In particular, depending on the evaluation, a message is issued, and/or the rotational speed is reduced or increased and/or a flow pattern of the gearbox fluid in the gearbox fluid circuit is controlled and/or adjusted.

The message is, for example, a warning message to the operator of the wind energy installation, or a control room from which the operation of the wind energy installation is monitored. Depending on the warning communication, the operating parameters, such as, for example, the generator torque and the generator rotational speed can be changed, or a braking procedure is initiated by changing the rotor blade angle (a “rotation out of the wind” of the rotor blades of a rotor of the wind energy installation) and/or by a mechanical brake. The control and/or adjustment of the flow pattern of the gearbox fluid in the gearbox fluid circuit consists, for example, in switching bypass flow paths, etc. on or off.

The invention moreover relates to a computer program product which is designed to carry out an above-mentioned method for monitoring a gearbox of a wind energy installation comprising said gearbox and a gearbox fluid circuit.

The monitoring system according to the invention for monitoring a gearbox of a wind energy installation comprising said gearbox and at least one gearbox fluid circuit comprises at least one particle detector, at least one unit for determining an operating characteristic variable, and an analysis and/or control and/or adjustment device. Here, the analysis, control and/or adjustment device preferably includes a data processing device, and it is designed for carrying out an above-mentioned monitoring method by means of this data processing device. The data processing device is set up in particular for carrying out the method by means of the computer program product. The particle detector is a detector for determining at least one particle characteristic variable, in particular the quantity and/or the size and/or the type of particles contained in the gearbox fluid, by measurement. In particular, several measurement positions are provided.

In the simplest case, the at least one particle detector is arranged in an associated measurement position within the gearbox fluid circuit. In this case, a particle detector is provided on the measurement position or on each one of the measurement positions.

Alternatively or additionally to this case, it is provided that at least one connectable path of the gearbox fluid circuit fluidically connects at least one of the gearbox positions to the at least one particle detector, wherein a valve in this path is selectable for switching this path of the analysis, control and/or adjustment device on or off via a signaling connection. By means of this signaling connection, the analysis, control and/or adjustment device issues control commands (on/off) to the valve for activating it.

According to a preferred embodiment of the invention, the at least one gearbox position is formed in a collection structure formed in the gearbox fluid circuit, for the purpose of accumulating particles contained in the gearbox fluid.

Finally, the invention relates to a wind energy installation with a gearbox that has a gearbox fluid circuit, and with an above-mentioned monitoring system.

The invention is explained below in further detail in reference to the associated drawings:

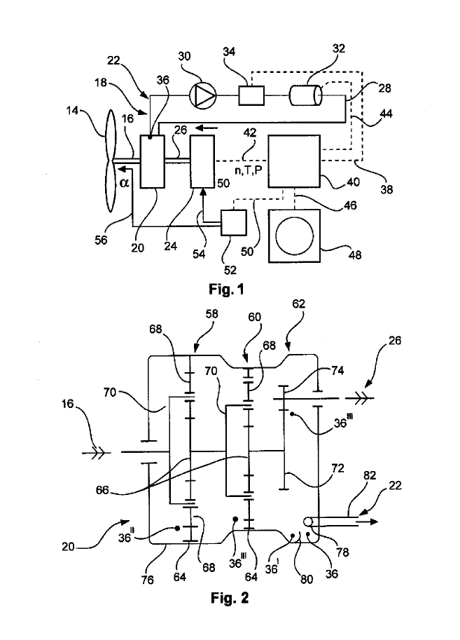

FIG. 1 shows a wind energy installation with gearbox, gearbox fluid circuit and with a monitoring system for monitoring the gearbox according to a first preferred embodiment of the invention,

FIG. 2 shows a gearbox in a detailed cross-sectional representation and gearbox positions drawn therein, from which gearbox fluid is sampled for measurements, and

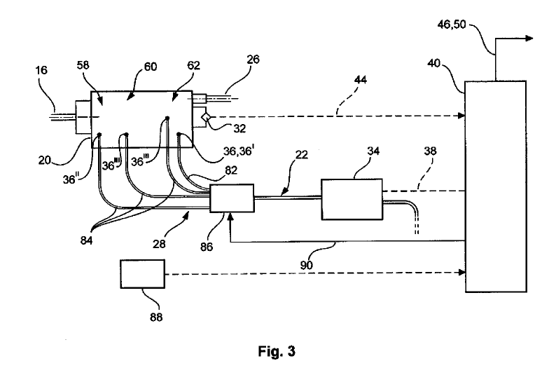

FIG. 3 shows the gearbox shown in FIG. 2, a corresponding gearbox fluid circuit, and a monitoring system for monitoring the gearbox according to a second preferred embodiment of the invention.

In FIG. 1, a drive train 10 of a wind energy installation (WEI) 12 is represented diagrammatically. The drive train includes a rotor 14 with rotor shaft 16, a gearbox unit 18 with a gearbox 20 and with a gearbox fluid circuit 22, as well as a generator 24 with generator shaft 26. Here, the rotor shaft 16 is connected via the gearbox 20 to the generator shaft 26 of the downstream generator 24. The gearbox fluid in the circuit 22 is a gearbox oil for lubricating and cooling the moving parts in gearbox 20. The gearbox fluid circuit 22 comprises a line system 28 for the gearbox fluid in the form of a gearbox oil, a fluid pump 30 designed as an oil pump, and a particle filter 32. A fluid reservoir or an (oil) pan is not represented but can be present. In the shown example of FIG. 1, between the fluid pump 30 and the particle filter 32, in which wear particles from the gearbox 20 are filtered out of the circuit 22, a particle detector (particle counter) 34 is arranged, in which particles in the gearbox fluid circuit 22 are counted before they are filtered out of the gearbox fluid circuit 22 by means of the particle filter 32. The gearbox 20 itself forms a portion of the gearbox circuit 22, wherein the gearbox fluid is sampled on at least one gearbox position 36 from the gearbox 20 and transferred to the remainder of the gearbox circuit. The particle detector 34 arranged in the remainder of the gearbox circuit 22 can be the only particle detector or one among many particle detectors 34 which determine(s) the quantity and/or the size and/or the type of the particles on an individual gearbox position or on different gearbox positions in gearbox 20. Pertinent details can be obtained in particular from FIGS. 2 and 3.

The term “gearbox position” here does not necessarily relate to the site where the measurement itself takes place (that is to say the measurement site) but it relates also to the position within the gearbox 20 from which the liquid sample is removed, in which the particle data are determined by means of the particle detector 34. The gearbox position 36 can here coincide with the measurement site, but the gearbox position 36 can also be a sampling site from which the gearbox fluid sample is transported within the remainder of the gearbox circuit 22 to the measurement site.

The particle detector 34 is in particular an inductive particle counter. By means of this inductive particle counter, the quantity and/or the size and/or the type of metal or magnetizable particles is/are determined by inductive measurement. Alternatively, an optical particle detector, or a combination of one or more optical and inductive particle detectors, can also be provided. The measurement data of the particle detector 34, which can be either a digital or an analog signal, are transmitted via a data line 38—represented using a broken line—to an analysis device 40.

By means of corresponding units, such as, for example, measurement units (shown in FIG. 3), operating characteristic variables (rotational speed n, generator output power P, gearbox fluid temperature T, etc.) of the wind energy installation 12 and/or of the gearbox 20 are determined, by means of which a current operating state of the wind energy installation 12 and/or of the gearbox 20 at the moment of the measurement of the particle detector 34 can be determined. The data of the operating characteristic variables n, P, T are also transmitted as digital or analog signal via a data line 42—represented using a broken line—to the analysis device 40. From these operating characteristic variables or from some of these operating characteristic variables, the analysis device 40 determines a current operating state of the wind energy installation 12 and/or of the gearbox 20 at the respective moment of the measurement of the measurement data of the particle sensor 34. A subsequent analysis of the measurement data also occurs in the analysis device 40 according to the operating state so determined. Operating states can be, for example, “out of service,” partial load operation (operation in case of weak wind) and full load operation.

Moreover, a loading state of the particle filter 32 is also determined. The corresponding data of this loading state, like the data of the operating characteristic variables, are transmitted via data line 44 to the analysis device 40.

In the analysis device 40, the cumulative quantity of particles, the quantity of particles per unit of time or their change, the size of the particles, the size distribution of the particles, the change in the size distribution of the particles, the types of the particles, the distribution of the particle types and/or their change over time are evaluated and analyzed for the presence of damage to the gearbox or to determine the general gearbox state of the gearbox 20. For the evaluation, the measurement value or the measurement values is/are compared to limit values stored in the analysis device 40. The limit values are dependent on the current operating state of the gearbox 20 and/or the entire wind energy installation 12. Optionally, the limit value is moreover dependent on data of the loading state of the particle filter 32. The analysis device 40 in particular comprises a data storage in which the limit values are stored according to the operating states and optionally according to the loading state of the particle filter 32.

As a result of the monitoring, it is possible for the analysis device 40 to transmit, via an additional data line 46 represented using a broken line, a status communication to a display device 48 or another display device. The status communication can include the instantaneous gearbox state, an alarm communication, a message regarding a change of at least one operating parameter of the wind energy installation 12 and/or a communication to the effect that a repair step has been instituted.

The display device 48 is, for example, arranged in a central remote monitoring unit for a wind farm with several wind energy installations 12. However, the display device 48 can also be a computer monitor which is connected by signaling means at the site of the analysis device 40 to the analysis device 40, wherein the analysis device 40 is implemented as computer, for example. The analysis device 40 can be arranged, for example, in a gondola of the wind energy installation 12 or in the central remote monitoring unit. A display device 48 can also be provided both in the gondola of a wind energy installation 12 and also in a central remote monitoring unit.

Via a data line 50, represented using a broken line, the analysis device 40 activates a control device 52 which can change different operating parameters n, P, T, depending on the type of signal. FIG. 1 shows that the control device 52 changes the generator torque T via a control signal line 54 on the generator 24. Thus, the generator torque can be set to zero in extreme cases. Alternatively or additionally, it is possible for the control device 52 to control the rotor blade angle α via an additional control signal line 56. By way of the rotor blade angle α, it is also possible to reduce the load of the gearbox 20. The rotor blade angle α can be changed sufficiently so that in vane position the rotor 14 no longer turns and the wind energy installation 12 is brought to standstill.

However, it is advantageous—in contrast to the representation of FIG. 1—to provide several gearbox positions 36, 36′, 36″, 36′″ in the gearbox 20. These gearbox positions 36, 36′, 36″, 36′″ or at least some of these gearbox positions 36, 36′, 36″, 36′″ are arranged in a distribution over the portion of the gearbox fluid circuit 22 running through the gearbox 20 itself. Some of these gearbox positions 36 are located in the region of known high-wear parts of the gearbox 20. At least one gearbox position 36 is located in the main flow of the gearbox fluid circuit 22. Advantageously, a gearbox position 36′ is located in a secondary flow of the gearbox fluid circuit 22. In the secondary flow, it is possible, for example, to clearly reduce the flow rate of the particles relative to the main flow, as a result of which a more precise analysis of the particles, for example, with regard to the particle size or the composition, can be carried out. Naturally, the limit values for an analysis in the secondary flow have to be adapted to the circumstances, i.e., as a rule they have to be reduced considerably.

FIG. 2 shows a detailed cross-sectional representation through an advantageous embodiment of the gearbox 20. The gearbox 20 has three series-connected gearbox stages 58, 60, 62. The first two gearbox stages 58, 60 are formed as planet gear stages. They each comprise a ring gear 64, a sun gear 66, planet gears 68 meshing with the sun gear 66, and a planet carrier 70 carrying the planet gears. The rotor shaft 16 is connected at the inlet of the gearbox 20 to the planet carrier 64 of the first gearbox stage 58. The sun gear 66 of the first gearbox stage 58 is connected to the planet carrier 64 of the second gearbox stage 60, and the sun gear 66 of the second gearbox stage 60 is connected to the first gear wheel 72 of the third gearbox stage 62. This first gear wheel 72 meshes with a second gear wheel 74 of the third gearbox stage 62, which itself is rotatably connected to the generator shaft 26. Here, the diameter of the first gear wheel 72 is greater than that of the second gear wheel 74 of the third gearbox stage 62. All three gearbox stages 58, 60, 62 are housed in a gearbox housing 76.

Due to the resulting transmission of the gearbox 20, a relatively slow rotation of the rotor shaft 16 is converted into a clearly more rapid rotation of the generator shaft 26. Thus, the first gear stage 58 is a (relatively) slowly running stage, and the other stages 60, 62 (that is to say in particular the third stage 62) are rapidly running stages.

The gearbox housing 76 is flushed with gearbox fluid by means of the gearbox fluid circuit 22. Via the discharge 78 of the gearbox 20, a main flow of the gearbox fluid is transferred into the remainder of the gearbox fluid circuit 22. At this site, one of the gearbox positions 36 is located, wherein the quantity and/or the size and/or the type of the particles contained in the gearbox fluid is/are determined by measurement. The measurement site or respectively the corresponding particle detector 34 is located, in the shown embodiment example, in the remainder of the gearbox fluid circuit 22 outside of the gearbox housing 76. An additional gearbox position 36′ is located, for example, close to the discharge 78 in a collection structure 80 for the accumulation of particles contained in the gearbox fluid, that is in the secondary flow. This collection structure 80 arranged in the gearbox 20 is shaped, for example, in the form of a basin. Other gearbox positions 36″, 36′″ are located in the immediate vicinity of slowly moving gearbox parts (gearbox position 36″) and/or of faster moving gearbox parts (gearbox position 36′″) and/or in the vicinity of known and/or critical regions that are subject to wear.

FIG. 3 shows the gearbox 20 of FIG. 2 in addition to a partial region of the gearbox fluid circuit 22 and of the analysis device 40 of a monitoring system for monitoring the gearbox 20. The particle filter 32 is attached as add-on component directly to gearbox 20, but in the gearbox fluid circuit 22. The line system 28 of the gearbox fluid circuit 22 moreover comprises, in addition to a main line 82, bypass lines 84. The main line 82 connects the (main) discharge 78 to a valve 86 (valves or to components for controlling a gearbox fluid circuit); the bypass lines 84 connect the other gearbox positions to this valve 86. By means of this valve 86, the individual bypass lines can be connected, in particular they can be connected separately. The particle sensor 34 located fluidically after the valve 86 in the gearbox fluid circuit 22 can thus measure the individual particle data and transmit them to the analysis device 40 which, based on the measurement data, determines the quantity of particles per unit of volume of the gearbox fluid and/or their size and/or the type of the particles for the individual gearbox positions.

Moreover, the monitoring system comprises at least one operating characteristic variable determination device 88. By means of this device 88, the data of at least one operating characteristic variable n, P, T are determined and transmitted to the analysis device via the data line 42. The analysis device 40 comprises a data processing unit (not shown) by means of which the analysis device 40 determines a current operating state of the wind energy installation 12 overall and/or of the gearbox 20 at the moment of the at least one measurement. The determination here can also be a rough estimation. The valve 86 can be activated by the analysis device via an additional control signal line 90.

An evaluation of at least one measurement occurs according to the so determined operating state of the wind energy installation 12 and/or of the gearbox 20. Here, the measurements are used, after having been weighted, in the evaluation, wherein this weighting is selected or modified according to the current determined operating state.

According to the evaluation, a communication is issued via one of the additional data lines 46 and the display device 48 or another display apparatus, and/or, via one of the additional data lines 50, the control device 52 is activated, which changes different operating parameters α, M of the wind energy installation, depending on the type of signals.

Formulated more generally, by means of such a monitoring method, more precisely by means of the evaluation of the at least one measurement according to the operating state so determined, messages and/or countermeasures can be generated automatically and these countermeasures can preferably also be initiated automatically.

### LIST OF REFERENCE NUMERALS

10 Drive train
12 Wind energy installation (WEI)
14 Rotor
16 Rotor shaft
18 Gearbox unit
20 Gearbox
22 Gearbox fluid circuit
24 Generator
26 Generator shaft
28 Line system
30 Fluid pump
32 Particle filter
34 Particle detector
36, 36′, 36″, 36′″ Gearbox position
38 Data line
40 Analysis device
42 Data line
44 Data line
46 Data line
48 Display device
50 Data line
52 Control device
54 Control signal line
56 Control signal line
58 First gearbox stage
60 Second gearbox stage
62 Third gearbox stage
64 Ring gear
66 Sun gear
68 Planet gear
70 Planet carrier
72 First gear wheel
74 Second gear wheel
76 Gearbox housing
78 Discharge
80 Collection structure
82 Main line
84 Bypass line
86 Valve
88 Determination apparatus
90 Control signal line

1. Method for monitoring a gearbox (20) of a wind energy installation (12) comprising said gearbox (20) and at least one gearbox fluid circuit (22), in which method at least one particle characteristic variable of particles contained in the gearbox fluid, in particular the quantity and/or the size and/or the type of these particles, is determined by measurement on at least one gearbox position (36, 36′, 36″, 36′″) in the gearbox (20) and/or by fluid sampling on at least one such gearbox position (36, 36′, 36″, 36′″), and a subsequent measurement of the particle characteristic variable of the particles contained in the gearbox fluid is determined in a path of the gearbox fluid circuit (22), characterized in that moreover at least one operating characteristic variable (n, P, T) is determined, by means of which a current operating state of the wind energy installation (12) and/or of the gearbox (20) at the moment of the at least one measurement is determined, and wherein at least one measurement is evaluated according to the operating state thus determined.

2. Method according to claim 1, wherein several measurements of particles contained in the gearbox fluid of different gearbox positions (36, 36′, 36″, 36′″) are carried out, wherein the measurements, after having been weighted, are used in the evaluation.

3. Method according to claim 2, wherein this weighting is selected according to the current determined operating state.

4. Method according to claim 2 or 3, wherein, the flow pattern of the flow of the gearbox fluid during operation in at least one first gearbox position of the gearbox positions (36″) is maintained by means of at least one fluidic structure in such a manner that it deviates in a controlled manner from the flow pattern of the flow of the gearbox fluid during operation in at least one second gearbox position of the gearbox positions (36′).

5. Method according to one of claims 2 to 4, wherein a dead region, which is produced by detached laminar and/or turbulent flow, is used in a defined manner as at least one of the gearbox positions.

6. Method according to one of claims 2 to 5, wherein at least one of the gearbox positions (36′) is formed in a collection structure (80) formed in the gearbox (20) for accumulating particles contained in the gearbox fluid.

7. Method according to one of the previous claims, wherein the at least one operating characteristic variable is selected from the group of the following operating characteristic variables:
rotational speed (n) at the inlet of the gearbox (20),
torque at the inlet of the gearbox (20),
power (P) of a generator (24) of the wind energy installation (12),
wind speed in the region of a rotor (14) of the wind energy installation (12),
ambient temperature of the gearbox (20),
quantity of the previous braking procedures for braking the rotor (14),
hours of operation of the gearbox (20) and/or generator (24),
gearbox fluid temperature (T),
service intervals,
volume flow in the fluid pump (30), and
mechanical vibrations of the gearbox.

8. Method according to one of the previous claims, wherein, in addition to the at least one particle characteristic variable, moreover at least one chemical and/or physical property and/or one chemical and/or physical state of the gearbox fluid is also determined by measurement.

9. Method according to one of the previous claims, wherein the gearbox fluid circuit (22) comprises a particle filter (32), and the measurements are also evaluated according to a current loading state of the particle filter (32).

10. Method according to one of the previous claims, wherein a message is issued in accordance with the evaluation and/or the rotational speed is reduced or increased and/or a flow pattern of the gearbox fluid in the gearbox fluid circuit (22) is controlled and/or adjusted.

11. Computer program product, which is designed to carry out a method for monitoring a gearbox (20) of a wind energy installation (12) according to one of claims 1 to 10, comprising said gearbox (20) and a gearbox fluid circuit (22).

12. Monitoring system for monitoring a gearbox (20) of a wind energy installation (12) comprising said gearbox (20) and at least one gearbox fluid circuit (22), with at least one particle detector (34), at least one unit for determining at least one operating characteristic variable (n, P, T) and one analysis, control and/or adjustment device (40, 52), wherein the analysis, control and/or adjustment device (40, 52) comprises a data processing unit and is designed for carrying out a method according to one of claims 1 to 8 by means of this data processing unit.

13. System according to claim 12, wherein at least one connectable path of the gearbox fluid circuit (22) fluidically connects at least one of the gearbox positions (36, 36′) to the at least one particle detector (34), wherein a valve (86) in this path is selectable for switching this path of the analysis, control and/or adjustment device (40, 52) on or off.

14. Wind energy installation (12) with a gearbox (20), a gearbox fluid circuit (22), and a monitoring system according to claim 12 or 13.
